(19) United States
(12) Patent Application Publication
(10) Pub. No.: US 2004/0040608 A1
(43) Pub. Date: Mar. 4, 2004

(54) Automotive fuel hose

(75) Inventors: Hiroaki Ito, Kasugai-shi (JP); Kazutaka Katayama, Kasugai-shi (JP); Junichiro Suzuki, Kasugai-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TOKAI RUBBER INDUSTRIES, LTD., Komaki-shi (JP)

(21) Appl. No.: 10/648,473

(22) Filed: Aug. 27, 2003

(30) Foreign Application Priority Data
Aug. 30, 2002 (JP) JP2002-254581

(51) Int. Cl. F16L 11/00

(52) U.S. Cl. 138/137; 138/141; 428/36.91

(57) ABSTRACT

An automotive fuel hose of low fuel permeability, and excellent in impact resistance, hydrolysis resistance, and inter-layer adhesion. The automotive fuel hose comprises: a tubular inner layer (1) comprising a fluororesin having a functional group; and a low fuel permeability layer (2) comprising a polyester resin having a naphthalene ring; the inner layer in which fuel is adapted to flow; the low fuel permeability layer being laminated onto the inner layer such that respective mating interfaces contact each other.

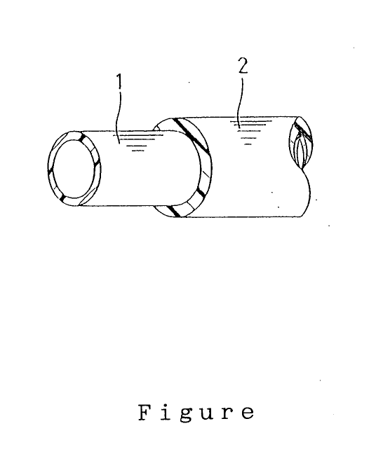

### BACKGROUND OF THE INVENTION

1. Field of the Invention

The present invention relates to an automotive fuel hose for transportation of an automotive fuel, specifically to an automotive fuel hose for transportation of gasoline, alcohol-containing gasoline, diesel fuel or the like.

2. Description of the Art

With growing worldwide awareness of environmental issues, the control of the amount of hydrocarbon vapor emission from an automotive fuel hose has been enhanced. Particularly in the United States, stringent regulations against vapor emission have recently come into effect. To cope with the hydrocarbon vapor emission control in this situation, multi-layer hoses have been proposed which include a layer having low fuel permeability such as composed of a fluororesin, a polyester resin or a polyphenylene sulfide (PPS) resin. A multi-layer hose including a fluororesin layer has a relatively low permeability. To satisfy a stricter low-permeability requirement, the thickness of the fluororesin layer should be increased, resulting in correspondingly higher costs. On the other hand, the polyester resin and the PPS resin are higher in permeation resistance than the fluororesin and, therefore, a layer composed of the polyester resin or the PPS resin has a satisfactory permeation resistance even if it has a relatively small thickness. The polyester resin layer and the PPS resin layer are advantageous in terms of costs, but have difficulty in lamination because of their poorer adhesion.

To solve the aforesaid drawback, the following hoses (1) to (5) have been proposed.

As proposed in Japanese Patent No. 3126275, a hose (1) has a five-layer structure consisting of a fluororesin layer, a first adhesive resin layer, a polybutylene naphthalate layer, a second adhesive resin layer and a thermoplastic resin layer stacked in this order from the inner side thereof. The first adhesive resin layer for bonding the fluororesin layer and the polybutylene naphthalate layer is formed by a mixture of a fluorine-containing material and a crystalline polyester or a polyester elastomer blended with a compatibilizing agent.

As proposed in Japanese Unexamined Patent Publication No. 7-173446 (1995), a hose (2) comprises an inner layer formed by a graft-modified ETFE (a copolymer of ethylene and tetrafluoroethylene) and an outer layer formed by a polybutylene terephthalate provided on an outer peripheral surface of the inner layer.

As proposed in International Publication No. WO98/58973, a hose (3) has a laminated structure of a layer comprising tetrafluoroethylene copolymer wherein terminals are modified with polycarbonate and a layer comprising at least one other polymer such as a polyamide resin, a polyolefin resin or epoxy resin.

As proposed in International Publication No. WO98/55557, a hose (4) has a laminated structure of a layer formed by a copolymer consisting of (a) a fluorine-containing ethylene monomer having a carboxyl group or a carboxylate and (b) a fluorine-containing ethylene monomer capable of copolymerization with the above-mentioned (a) and not containing any of the above-mentioned functional groups, and a layer comprising a thermoplastic resin.

As proposed in International Publication No. WO98/45044, a hose (5) has a laminated structure of a layer comprising a fluorine-containing ethylene polymer having a carbonate group or a carboxylic halide group and a layer comprising at least one other polymer such as a polyamide resin, a polyester resin or a polycarbonate resin.

However, hose (1) is disadvantageous in that adhesion between the innermost fluororesin layer and the intermediate polybutylene naphthalate layer is very poor. If the adhesion between the inner layer and the intermediate polybutylene naphthalate layer which serves to prevent the permeation of a fuel is insufficient, the inner layer tends to delaminate, thereby reducing the inner space of the hose. This may result in clogging of the hose or reduction in the flow rate of the fuel through the hose. Since the first adhesive resin layer for bonding the fluororesin layer and the polybutylene naphthalate layer is formed by a mixture with a fluorine-containing material, the resultant layer is disadvantageous in that impact resistance is poor and cost becomes high. Since the outer layer of the above hose (2) is formed by a polybutylene terephthalate, the resultant hose has high fuel permeability and poor hydrolytic resistance due to hydrolysis with alcohol or water contained in fuel. The above hoses (3) to (5) are insufficient in fuel permeability, impact resistance and inter-layer adhesion.

In view of the foregoing, it is an object of the present invention to provide an automotive fuel hose excellent in low fuel permeability, impact resistance, hydrolysis resistance and inter-layer adhesion.

### SUMMARY OF THE INVENTION

In accordance with the present invention to achieve the aforesaid object, there is provided an automotive fuel hose, which comprises: a tubular inner layer comprising a fluororesin having a functional group; and a low fuel permeability layer comprising a polyester resin having a naphthalene ring; the inner layer in which fuel is circulated; the low fuel permeability layer being laminated onto the inner layer such that respective mating interfaces contact each other.

The inventors of the present invention conducted intensive studies to provide an automotive fuel hose excellent in low fuel permeability, impact resistance, hydrolysis resistance and inter-layer adhesion. As a result, it was found that, where an inner layer is formed by a fluororesin having a functional group and a low fuel permeability layer is formed by a polyester resin having a naphthalene ring on an outer peripheral surface of the inner layer, adhesion between the inner layer and the low fuel permeability layer can be enhanced. This is because the functional groups of the fluororesin interact with terminal carboxyl groups or terminal hydroxyl groups of the polyester resin having the naphthalene ring. At the first stage of the studies, the inventors thought that the polyester resin having the naphthalene ring, such as a polybutylene naphthalate or a polyethylene naphthalate, has poor reactivity with the fluororesin having the functional group, resulting in poor adhesion, because the naphthalene ring causes steric hindrance. However, as a result of further experiments, the inventors found that the adhesion with the fluororesin having the functional group is better in the case of using polyester resin having the naphthalene ring, such as a polybutylene naphthalate or a polyethylene naphthalate, than in the case of using a polybutylene terephthalate which is thought to have less steric hindrance due to no naphthalene ring. Thus, the present invention has been attained.

### BRIEF DESCRIPTION OF THE DRAWINGS

The sole figure of the drawing is a diagram illustrating the construction of an exemplary fuel hose according to the present invention.

### DESCRIPTION OF THE PREFERRED EMBODIMENTS

Embodiments of the present invention will hereinafter be described in detail.

As shown in Figure, an automotive fuel hose according to one embodiment of the present invention includes an inner layer 1 in which fuel is circulated and a low fuel permeability layer 2 provided on an outer peripheral surface of the inner layer 1. The inner layer 1 and the low fuel permeability layer 2 are directly provided such that respective mating interfaces contact each other, no application of an adhesive or no plasma treatment is required on the interfaces.

The fluororesin having the functional group is employed as a material for the inner layer 1.

The fluororesin is not particularly limited, but examples thereof include a copolymer of ethylene and tetrafluoroethylene (ETFE); a copolymer of tetrafluoroethylene and hexafluoropropylene (FEP); a copolymer of ethylene and chlorotrifluoroethylene (ECTFE); a copolymer of vinylidene fluoride and hexafluoropropylene; a copolymer of vinylidene fluoride and chlorotrifluoroethylene; a copolymer of vinylidene fluoride and tetrafluoroethylene; a copolymer of vinylidene fluoride, tetrafluoroethylene and hexafluoropropylene (THV); a copolymer of vinylidene fluoride, tetrafluoroethylene, hexafluoropropylene and perfluoroalkoxyvinyl ether; and a copolymer of tetrafluoroethylene, vinylidene fluoride, hexafluoropropylene, and perfluoroalkoxyvinyl ether. These fluororesins may be used either alone or in combination. Among these fluororesins, ETFE and THV are particularly preferred because of their excellent workability.

The functional group for the fluororesin is not particularly limited, but examples thereof include an epoxy group, a hydroxyl group, a carboxylic anhydride residual group, an acrylate group and an amino group.

The fluororesin having the functional group may be obtained by grafting a grafted compound having a functional group in the fluororesin or copolymerizing a compound having a functional group in its main chain or at a terminal of the fluororesin.

The impact strength of the fluororesin having the functional group preferably is not less than 30 J/m at −40° C., more preferably not less than 45 J/m. The impact strength may be measured in accordance with ASTM D256 (notched izod).

The inner layer 1 may be electrically conductive so as not to charge fuel with static electricity mainly generated by a fuel pump. Thus, an accident such as ignition of the fuel caused by a spark can effectively be prevented. In this case, an electrically conductive material such as carbon black, carbon-nano tubes, metal powder or metal oxide powder preferably is blended in the aforesaid inner layer material. Where the inner layer is thus imparted with electrical conductivity, the inner layer (electrically conductive layer) preferably has a surface electric resistance of not higher than 10⁶ Ω, particularly preferably not higher than 10⁵ Ω. The proportion of the electrically conductive material is preferably determined so that the surface electrical resistance falls within the aforesaid range.

The low fuel permeability layer 2 provided on the inner layer 1 is composed of a polyester resin having a naphthalene ring. Such a polyester resin is not particularly limited, but examples thereof include a polybutylene naphthalate (PBN) and a polyethylene naphthalate (PEN).

Polybutylene naphthalate (PBN) is a resin obtained by condensation between tetramethylene glycol and 2,6-naphthalenedicarboxylic acid or its ester compound. Polyethylene naphthalate (PEN) is a resin obtained by condensation between ethylene glycol and 2,6-naphthalenedicarboxylic acid or its ester compound.

The PBN or the PEN may be copolymerized with an ether segment or an ester segment so as to be used as a thermoplastic elastomer having flexibility within a range in such a manner to satisfy the low permeability. Further, the PBN or the PEN may be reacted with a dicarboxylic acid of a fatty acid in addition to naphthalene dicarboxylic acid in such a manner to satisfy the low permeability. Alternatively, the PBN or the PEN may be mixed with an elastomer such as an olefin elastomer or a fine-particle crosslinked elastomer in such a manner to satisfy the low permeability.

The PBN or the PEN preferably may have a permeability coefficient of not higher than 0.08. The permeability coefficient indicates a permeability coefficient (mg/mm/cm²/day/atm) of fuel composed of 90 volume % Fuel C (50% by volume of toluene+50% by volume of isooctane) and 10 volume % ethanol at 40° C. The permeability coefficient is measured in conformity with “Method A” of Japanese Industrial Standard (JIS) K7126.

The PBN or the PEN preferably has a viscosity of 90 to 260 cm³/g in consideration of a balance between extrudability and resistances to shock, heat and hydrolysis. The viscosity is determined at 35° C. in conformity with ASTM D 2857 by employing a solution obtained by dissolving the PBN or the PEN in a concentration of 0.005 g/cm³ in a solvent mixture of phenol and tetrachloroethane.

The structure of the inventive automotive fuel hose is not limited to that shown in Figure, but an outer layer (not shown) may be provided on an outer peripheral surface of the low fuel permeability layer 2 in consideration of providing flexibility suitable for hoses as well as chipping resistance.

The material for the outer layer is not particularly limited, but examples thereof include polyamide resins such as polyamide 6 (PA6), polyamide 66 (PA66), polyamide 612 (PA612), polyamide 11 (PA11), polyamide 912 (PA912) and polyamide 12 (PA12), a thermoplastic ester elastomer (TPEE), a thermoplastic polyolefin elastomer (TPO), a thermoplastic polyamide elastomer (TPAE) and a thermoplastic polystyrene elastomer (TPS), which may be used either alone or in combination. The outer layer is not limited to a single-layer structure and may have a multi-layer structure of two or more layers.

The low fuel permeability layer 2 and the outer layer may be bonded by means of an adhesive resin, as required. The specific adhesive resin is not particularly limited, but examples of the adhesive resin include epoxy resins, polyamide resins (PA), and thermoplastic styrene elastomers. These adhesive resins may be used either alone or in combination. A blend of a PBN, a polybutylene terephthalate (PBT), a thermoplastic PBN elastomer and/or a thermoplastic PBT elastomer may be employed as the adhesive resin.

In the present invention, the structure of the inner layer 1 is not limited to a single-layer structure as shown in Figure, but may be a multi-layer structure consisting of two or more sublayers. For example, the inner layer 1 may have a double-layer structure consisting of an electrically conductive inner sublayer and an electrically non-conductive outer sublayer. Likewise, the outer layer may have a multi-layer structure consisting of two or more sublayers.

The inventive automotive fuel hose shown in Figure is produced, for example, by the following process. First, each material of the aforesaid fluororesin having the functional group and of the aforesaid polyester resin having the naphthalene ring are prepared for an inner layer 1 and a low fuel permeability layer 2, respectively. Each material is extruded by means of an inner-layer material extruder and a low fuel permeability material extruder, respectively, and is combined in a die. The thus molten material is co-extruded into a tubular shape, which is passed through a sizing die, so that the intended fuel hose wherein the low fuel permeability layer is directly laminated onto an outer peripheral surface of the inner layer is produced. The formation of the inner layer 1 having a double-layer structure is achieved by simultaneously extruding each material from separate extruders and combining the resulting sublayers in a die. For formation of the outer layer having a double-layer structure, the outer layer may be formed likewise in the aforesaid manner. Further, when a hose is formed into a corrugated hose, the aforesaid molten material co-extruded into a tubular shape is passed through a corrugation forming machine so that a corrugated hose of specified dimensions may be formed.

The inventive automotive fuel hose thus produced preferably has an inner diameter of 4 to 40 mm, particularly preferably 6 to 30 mm, and an outer diameter of 6 to 44 mm, particularly preferably 8 to 32 mm. The inner layer 1 preferably has a thickness of 0.02 to 1.0 mm, particularly preferably 0.05 to 0.6 mm. The low fuel permeability layer 2 preferably has a thickness of 0.02 to 0.8 mm, particularly preferably 0.05 to 0.6 mm. Further, when an outer layer is formed, the outer layer generally has a thickness of 0.3 to 1.5 mm, preferably 0.5 to 1.0 mm.

The inventive automotive fuel hose may preferably be used as a transportation hose for automotive fuel such as gasoline, alcohol-containing gasoline, diesel fuel, compressed natural gas (CNG), liquefied petroleum gas (LPG), but is not limited thereto. The inventive automotive fuel hose may be used as a transportation hose for methanol, hydrogen, dimethylether (DME) or the like for applications such as for fuel cell-powered vehicles.

Next, an explanation will be given to Examples and Comparative Examples.

Prior to the explanation of Examples and Comparative Examples, the ingredients employed therein will be described below.

ETFE

The impact strength was 150 J/m at −40° C.

Electrically Conductive ETFE

An electrically conductive ethylene-tetrafluoroethylene copolymer (ETFE) was prepared by blending 15 wt % of electrically conductive carbon black (Denka black available from Denki Kagaku Kogyo K.K. of Tokyo, Japan) in ETFE. The thus obtained electrically conductive ETFE had an impact strength of 75 J/m at −40° C.

Epoxy-Modified ETFE

Epoxy-modified ETFE was prepared by blending 2 parts by weight (just abbreviated as ‘parts’, hereinafter) of glycidyl methacrylate and 2 parts of dicumyl peroxide relative to 100 parts of ETFE and melt-kneading the resultant mixture by means of a twin screw extruder. The thus obtained epoxy-modified ETFE had an impact strength of 60 J/m at −40° C.

Hydroxy-Modified ETFE

Hydroxy-modified ETFE was prepared by blending 1.5 parts of vinylmethoxy silane and 1.5 parts of dicumyl peroxide relative to 100 parts of ETFE and melt-kneading the resultant mixture by means of a twin screw extruder. The thus obtained hydroxy-modified ETFE had an impact strength of 55 J/m at −40° C.

Carboxylic Anhydride-Modified ETFE

Carboxylic anhydride-modified ETFE was prepared by blending 1.5 parts of maleic anhydride and 0.2 parts of dicumyl peroxide relative to 100 parts of ETFE and melt-kneading the resultant mixture by means of a twin screw extruder. The thus obtained carboxylic anhydride-modified ETFE had an impact strength of 62 J/m at −40° C.

Electrically Conductive Epoxy-Modified ETFE

Electrically conductive epoxy-modified ETFE was prepared by blending 15 parts of electrically conductive carbon black (Denka black available from Denki Kagaku Kogyo K.K. of Tokyo, Japan) relative to 100 parts of the epoxy-modified ETFE and melt-kneading the resultant mixture by means of a twin screw extruder. The thus obtained electrically conductive epoxy-modified ETFE had an impact strength of 49 J/m at −40° C.

Acrylate-Modified ETFE

Acrylate-modified ETFE was prepared by blending 2 parts of methyl acrylate and 2 parts of dicumyl peroxide relative to 100 parts of ETFE and melt-kneading the resultant mixture by means of a twin screw extruder. The thus obtained acrylate-modified ETFE had an impact strength of 45 J/m at −40° C.

Amino-Modified ETFE

Amino-modified ETFE was prepared by blending 2 parts of arylamine and 1.8 parts of dicumyl peroxide relative to 100 parts of ETFE and melt-kneading the resultant mixture by means of a twin screw extruder. The thus obtained amino-modified ETFE had an impact strength of 50 J/m at −40° C.

Carboxylate-Modified ETFE

Carboxylate-modified ETFE was prepared by reacting perfluoro-(9,9-dihydro-2,5-bistrifluoromethyl-3,6-dioxa-8-nonenoic acid), tetrafluoroethylene, and ethylene, and adding zinc acetate, and then melt-kneading the resultant mixture by means of a twin screw extruder. The thus obtained carboxylate-modified ETFE had an impact strength of 21 J/m at −40° C.

Carboxy-Modified ETFE

Carboxy-modified ETFE was prepared by blending 1.5 parts of maleic acid and 0.2 parts of dicumyl peroxide relative to 100 parts of ETFE and melt-kneading the resultant mixture by means of a twin screw extruder. The thus obtained carboxy-modified ETFE had an impact strength of 28 J/m at −40° C.

Epoxy-Modified THV

Epoxy-modified THV was prepared by blending 4 parts of glycidyl methacrylate and 2 parts of dicumyl peroxide relative to 100 parts of THV and melt-kneading the resultant mixture by means of a twin screw extruder. The thus obtained epoxy-modified THV had an impact strength of 60 J/m at −40° C.

PBN

A condensation product (TQB-OT available from Teijin Chemicals Ltd.) of tetramethylene glycol and 2,6-naphthalenedicarboxylic acid.

PBN-Ether

A PBN-ether was obtained by copolymerizing 10 parts of polytetramethylene glycol as an ether segment relative to 100 parts of PBN.

PBN-Ester

A PBN-ester was obtained by copolymerizing 10 parts of polycaprolactone as an ester segment relative to 100 parts of PBN.

PBN-Fatty Acid

PBN-fatty acid was obtained by copolymerizing dicarboxylic acid of fatty acid (PRIPOL 1008 available from Uniqema of Gouda, the Netherlands) with PBN in such a manner that dicarboxylic acid of fatty acid was present at 3 mol % based upon the total amount.

TPEE

Ester thermoplastic elastomer (HYTREL 5577 available from DuPont-Toray Co., Ltd. of Tokyo, Japan.)

AD (1)

A mixture obtained by blending ETFE, PBN and ethyleneglycidyl methacrylate in a weight ratio of 5:5:1. The mixture had an impact strength of 26 J/m at −40° C.

AD (2)

A mixture obtained by blending PA12, PBN and a thermoplastic polyurethane in a weight ratio of 4:4:1.

### EXAMPLE 1

Each extruder for an inner layer, a low fuel permeability layer and an outer layer was prepared, respectively. Each material was extruded by each extruder, and was combined in a die, and then passed through a sizing die, whereby a low fuel permeability PBN layer was formed directly on an outer peripheral surface of an inner epoxy-modified ETFE layer, and further an outer TPEE layer was formed directly on an outer peripheral surface of the low fuel permeability PBN layer. Thus, a fuel hose was produced which has an inner diameter of 6 mm and an outer diameter of 8 mm.

### EXAMPLES 2 TO 12 AND COMPARATIVE EXAMPLES 1 TO 6

Fuel hoses were produced in substantially the same manner as in Example 1, except that inner layer materials, low fuel permeability layer materials and outer layer materials shown in Tables 1 to 3 were employed. The formation of the inner layer having the double-layer structure is achieved by simultaneously extruding an inner sublayer material and an outer sublayer material from separate extruders and combining the resulting sublayers in a die. For formation of an adhesive layer, another extruder was utilized and an adhesive layer material was simultaneously extruded with each material and was combined in a die and passed through a sizing die.

The properties of the fuel hoses of Examples and Comparative Examples were evaluated in the following manner. The results are shown in Tables 1 to 3.

Gasoline Permeability

Opposite end portions of a 10 m long fuel hose (having an inner diameter of 6 mm) were each expanded to an inner diameter of 10 mm by means of a cone-shaped jig. Then, two metal pipes were prepared which each had an outer diameter of 8 mm with two bulged portions each having an outer diameter of 10 mm and with each one end thereof having a rounded outer periphery. These metal pipes were respectively press-fitted into opposite end portions of the hose. A blind cap was threadingly attached to one of the metal pipes, and a metal valve was attached to the other metal pipe. Thereafter, regular gasoline (containing 10 vol % ethanol) was supplied into the fuel hose through the metal valve, and the fuel hose was sealed. The fuel hose was allowed to stand at 40° C. for 3000 hours (the regular gasoline was changed every week). Then, fuel permeation was measured for three days on the basis of a Diurnal Breathing Loss (DBL) pattern by the Sealed Housing for Evaporative Detection (SHED) method in accordance with California Air Resources Board (CARB). Then, fuel permeation per meter of the hose was determined on a day when the maximum fuel permeation was detected. In Tables 1 to 3, the notation “<0.1 indicates that the measured fuel permeation was below the measurement limitation (0.1 mg/m/day) of the aforesaid measurement method.

Hydrolysis Resistance

Each fuel hose was filled with pure water. Then, after being aged at 80° C. for 1,000 hours, the fuel hose was bent. The low fuel permeability layer was visually inspected for evaluation of the hydrolysis resistance. In Tables 1 to 3, a symbol ◯ indicates that no cracking was observed on the low fuel permeability layer, and a symbol × indicates that the low fuel permeability layer was cracked.

Adhesion

The fuel hoses were each longitudinally cut into four strips. By using one of the strips, a peel force (N/cm) required for separating the inner layer from the low fuel permeability layer was determined. Separetely, fuel hoses were each filled with a fuel (prepared by blending 10 vol % of ethanol in 90 vol % of Fuel C (50% by volume of toluene+50% by volume of isooctane) and allowed to stand still at 60° C. for one week. Adhesion (N/cm) between the inner layer and the low fuel permeability layer was determined in the same manner as described above.

Impact Resistance

Soon after each fuel hose was allowed to stand at −40° C. for 4 hours, a drop-weight test was conducted in conformity with JASO M317 in such a manner that a falling weight (round rod having a diameter of 32 mm and 450 g and both ends thereof with 16 mm radius of curvature, respectively) was dropped from the height of 305 mm onto each fuel hose. Then, each hose was cut into halves longitudinally, and occurrence of abnormality was visually evaluated on both inner and outer sides of each fuel hose. In Tables 1 to 3, a symbol ◯ indicates that no cracking was observed on the low fuel permeability layer, and a symbol × indicates that the low fuel permeability layer was cracked.

TABLE 1

| | Example | | | | | |
|---|---|---|---|---|---|---|
| | 1 | 2 | 3 | 4 | 5 | 6 |
| Inner layer | Epoxy- | Hydroxy- | Carboxylic | Epoxy- | Epoxy- | Epoxy- |
| | modified | modified | anhydride- | modified | modified | modified |
| | ETFE | ETFE | modified | ETFE | ETFE | ETFE |
| | | | ETFE | | | |
| Low fuel per- | PBN | PBN | PBN | PBN- | PBN- | PBN-fatty |
| meability layer | | | | ether | ether | acid |
| Outer layer | TPEE | TPEE | TPEE | TPEE | TPEE | TPEE |
| Thickness (mm) | | | | | | |
| Inner layer | 0.2 | 0.2 | 0.2 | 0.2 | 0.2 | 0.2 |
| Low fuel per- | 0.1 | 0.1 | 0.1 | 0.1 | 0.1 | 0.1 |
| meability layer | | | | | | |
| Outer layer | 0.7 | 0.7 | 0.7 | 0.7 | 0.7 | 0.7 |
| Gasoline permea- | <0.1 | <0.1 | <0.1 | <0.1 | <0.1 | <0.1 |
| bility (mg/m/day) | | | | | | |
| Hydrolysis | ◯ | ◯ | ◯ | ◯ | ◯ | ◯ |
| resistance | | | | | | |
| Adhesion (N/cm) | | | | | | |
| Initial | 36 | 33 | 31 | 35 | 35 | 36 |
| After filled | 32 | 26 | 26 | 32 | 31 | 31 |
| with fuel | | | | | | |
| Impact resistance | ◯ | ◯ | ◯ | ◯ | ◯ | ◯ |

TABLE 2

| | Example | | | | | |
|---|---|---|---|---|---|---|
| | 7 | 8 | 9 | 10 | 11 | 12 |
| Inner layer | | | | | | |
| Inner sublayer | Electri- | Electri- | Epoxy- | Epoxy- | Acrylate- | Amino- |
| | cally | cally | modified | modified | modified | modified |
| | conductive | conductive | ETFE | THV | ETFE | ETFE |
| | epoxy- | ETFE | | | | |
| Outer sublayer | modified | Epoxy- | | | | |
| | ETFE | modified | | | | |
| | | ETFE | | | | |
| Low fuel per- | PBN | PBN | PBN | PBN-ether | PBN | PBN |
| meability layer | | | | | | |
| Adhesive layer | — | — | AD (2) | — | — | — |
| Outer layer | TPEE | TPEE | PA12 | TPEE | TPEE | TPEE |
| Thickness (mm) | | | | | | |
| Inner layer | | | | | | |
| Inner sublayer | 0.2 | 0.1 | 0.2 | 0.2 | 0.2 | 0.2 |
| Outer sublayer | | 0.1 | | | | |
| Low fuel per- | 0.1 | 0.1 | 0.1 | 0.1 | 0.1 | 0.1 |
| meability layer | | | | | | |
| Adhesive layer | — | — | 0.2 | — | — | — |
| Outer layer | 0.7 | 0.7 | 0.5 | 0.7 | 0.7 | 0.7 |
| Gasoline permea- | <0.1 | <0.1 | <0.1 | <0.1 | <0.1 | <0.1 |
| bility (mg/m/day) | | | | | | |
| Hydrolysis | ◯ | ◯ | ◯ | ◯ | ◯ | ◯ |
| resistance | | | | | | |
| Adhesion (N/cm) | | | | | | |
| Initial stage | 34 | 36 | 36 | 35 | 30 | 30 |
| After filled | 30 | 32 | 32 | 30 | 26 | 27 |
| with fuel | | | | | | |
| Impact resistance | ◯ | ◯ | ◯ | ◯ | ◯ | ◯ |

TABLE 3

| | Comparative Example | | | | | |
|---|---|---|---|---|---|---|
| | 1 | 2 | 3 | 4 | 5 | 6 |
| Inner layer | ETFE | Epoxy- | Carboxylate- | Carboxy- | Hydroxy- | Carboxylic |
| | | modified | modified | modified | modified | anhydride- |
| | | ETFE | ETFE * | ETFE | ETFE | modified |
| | | | | | | ETFE |
| Adhesive layer | AD (1) | — | — | — | — | — |
| Low fuel per- | PBN | PBT | PBN | — | PBT | PBT |
| meability layer | | | | | | |
| Adhesive layer | AD (2) | — | — | — | — | — |
| Outer layer | PA12 | TPEE | TPEE | PA12 | TPEE | TPEE |
| Thickness (mm) | | | | | | |
| Inner layer | 0.1 | 0.2 | 0.2 | 0.2 | 0.2 | 0.2 |
| Adhesive layer | 0.1 | — | — | — | — | — |
| Low fuel per | 0.1 | 0.1 | 0.1 | — | 0.1 | 0.1 |
| meability layer | | | | | | |
| Adhesive layer | 0.2 | — | — | — | — | — |
| Outer layer | 0.5 | 0.7 | 0.7 | 0.7 | 0.7 | 0.7 |
| Gasoline permea | <0.1 | 4 | <0.1 | 7 | 4 | 4 |
| bility (mg/m/day) | | | | | | |
| Hydrolysis resistance | ∘ | x | ∘ | ∘ | x | x |
| Adhesion (N/cm) | | | | | | |
| Initial | 22 | 35 | 15 | 34 | 30 | 28 |
| After filled with fuel | 18 | 31 | 12 | 28 | 24 | 22 |
| Impact resistance | x | ∘ | x | x | ∘ | ∘ |

*: A copolymer of carboxylate-modified ETFE and ETFE (a molar ratio of 5:95)

As can be understood from the results, the fuel hoses of the Examples were excellent in low fuel permeability, hydrolysis resistance, adhesion and impact resistance. When PEN was employed instead of PBN as a material for the low fuel permeability layer, it was confirmed by experiment that superior effects can be obtained the same as PBN.

On the other hand, the fuel hose of Comparative Example 1, whose inner layer was formed by ordinary ETFE having no functional group, was inferior in adhesion between the inner layer and the low fuel permeability layer. Further, since the adhesive layer between the inner layer and the low fuel permeability layer was formed by a mixture including fluorine material, impact resistance at a low temperature is poor and cost becomes high. The fuel hose of Comparative Example 2, whose low fuel permeability layer was composed of PBT, was inferior in low fuel permeability and hydrolysis resistance. Further, compared with Example 1, which has the same construction except that the low fuel permeability layer of Example 1 was formed by PBN, the fuel hose of Comparative Example 2 was inferior in adhesion both at an initial stage and after being filled with fuel. The fuel hose of Comparative Example 3, whose inner layer was formed by a copolymer of carboxylate-modified ETFE and ETFE, was inferior in adhesion, both at an initial stage and after being filled with fuel, and in impact resistance. The fuel hose of Comparative Example 4, which did not have a low fuel permeability layer, was inferior in low fuel permeability and impact resistance. The fuel hose of Comparative Example 5, whose low fuel permeability layer was formed by PBT, was inferior in low fuel permeability and hydrolysis resistance. Further, compared with Example 2, which has the same construction except that the low fuel permeability layer of Example 2 was formed by PBN, the fuel hose of Comparative Example 5 was inferior in adhesion both at an initial stage and after being filled with fuel. The fuel hose of Comparative Example 6, whose low fuel permeability layer is formed by PBT, was inferior in low fuel permeability and hydrolysis resistance. Still further, compared with Example 3, which has the same construction except that the low fuel permeability layer of Example 3 was formed by PBN, the fuel hose of Comparative Example 6 was inferior in adhesion both at an initial stage and after being filled with fuel.

As described above, the inner layer of the inventive automotive fuel hose is formed by the fluororesin having the functional group and the low fuel permeability layer is formed by the polyester resin having the naphthalene ring. Therefore, the functional group of the fluororesin interacts with the terminal carboxyl group or the terminal hydroxyl group of the polyester resin having the naphthalene ring, so that the adhesion therebetween is enhanced. Therefore, the inter-layer adhesion between the inner layer and the low permeability layer is excellent and impact resistance is improved. Further, since the low fuel permeability layer is formed by the polyester resin having the naphthalene ring, the inventive automotive hose is excellent in the low fuel permeability and in hydrolysis resistance.

When the impact strength of the fluororesin having the functional group for forming the inner layer is not less than 30 J/m at −40° C., the impact resistance of the resultant hose is improved and the hose is more practicable as an automotive fuel hose.

When the low fuel permeability layer is formed by PBN or PEN, the PBN or the PEN can be extruded at a higher temperature because each of the PBN or the PEN has a high melting point, respectively, so that the adhesion with the fluororesin having the functional group for the inner layer is further improved and the impact resistance of the resultant hose is improved.

What is claimed is:

1. An automotive fuel hose comprising: a tubular inner layer comprising a fluororesin having a functional group; and a low fuel permeability layer comprising a polyester resin having a naphthalene ring; the inner layer in which fuel is adapted to flow; the low fuel permeability layer being laminated onto the inner layer such that respective mating interfaces contact each other.

2. An automotive fuel hose as set forth in claim 1, wherein the fluororesin has impact strength of not less than 30 J/m at −40° C.

3. An automotive fuel hose as set forth in claim 1, wherein the polyester resin is either a polybutylene naphthalate or a polyethylene naphthalate.

4. An automotive fuel hose as set forth in claim 2, wherein the polyester resin is either a polybutylene naphthalate or a polyethylene naphthalate.

5. An automotive fuel hose as set forth in claim 1, wherein the functional group is at least one functional group selected from the group consisting an epoxy group, a hydroxyl group, a carboxylic anhydride residual group, an acrylate group and an amino group.

6. An automotive fuel hose as set forth in claim 2, wherein the functional group is at least one functional group selected from the group consisting an epoxy group, a hydroxyl group, a carboxylic anhydride residual group, an acrylate group and an amino group.

7. An automotive fuel hose as set forth in claim 3, wherein the functional group is at least one functional group selected from the group consisting an epoxy group, a hydroxyl group, a carboxylic anhydride residual group, an acrylate group and an amino group.

8. An automotive fuel hose as set forth in claim 4, wherein the functional group is at least one functional group selected from the group consisting an epoxy group, a hydroxyl group, a carboxylic anhydride residual group, an acrylate group and an amino group.

9. An automotive fuel hose as set forth in claim 1, wherein the fluororesin is either an ethylene-tetrafluoroethylene copolymer or a vinylidene fluoride-tetrafluoroethylene-hexafluoropropylene copolymer.

10. An automotive fuel hose as set forth in claim 2, wherein the fluororesin is either an ethylene-tetrafluoroethylene copolymer or a vinylidene fluoride-tetrafluoroethylene-hexafluoropropylene copolymer.

11. An automotive fuel hose as set forth in claim 3, wherein the fluororesin is either an ethylene-tetrafluoroethylene copolymer or a vinylidene fluoride-tetrafluoroethylene-hexafluoropropylene copolymer.

12. An automotive fuel hose as set forth in claim 4, wherein the fluororesin is either an ethylene-tetrafluoroethylene copolymer or a vinylidene fluoride-tetrafluoroethylene-hexafluoropropylene copolymer.

13. An automotive fuel hose as set forth in claim 5, wherein the fluororesin is either an ethylene-tetrafluoroethylene copolymer or a vinylidene fluoride-tetrafluoroethylene-hexafluoropropylene copolymer.

14. An automotive fuel hose as set forth in claim 6, wherein the fluororesin is either an ethylene-tetrafluoroethylene copolymer or a vinylidene fluoride-tetrafluoroethylene-hexafluoropropylene copolymer.

15. An automotive fuel hose as set forth in claim 7, wherein the fluororesin is either an ethylene-tetrafluoroethylene copolymer or a vinylidene fluoride-tetrafluoroethylene-hexafluoropropylene copolymer.

16. An automotive fuel hose as set forth in claim 8, wherein the fluororesin is either an ethylene-tetrafluoroethylene copolymer or a vinylidene fluoride-tetrafluoroethylene-hexafluoropropylene copolymer.
